(19) United States
(12) Patent Application Publication
(10) Pub. No.: US 2026/0352812 A1
(43) Pub. Date: Nov. 5, 2026

(54) VIDEO ENCODING/DECODING METHOD AND APPARATUS USING TEMPLATE OF CHROMA BLOCK

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Jung Kyung Lee, Seoul (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/484,817

(22) PCT Filed: May 9, 2024
(86) PCT No.: PCT/KR2024/006236

§ 371 Date: Nov. 14, 2025

(30) Foreign Application Priority Data
May 17, 2023 (KR) 10-2023-0063894
May 8, 2024 (KR) 10-2024-0060588

(51) Int. Cl. H04N 19/107; H04N 19/105; H04N 19/176; H04N 19/186

(52) U.S. Cl. CPC H04N 19/107; H04N 19/105; H04N 19/176; H04N 19/186

(57) ABSTRACT

A video decoding method includes obtaining first information indicating whether a template matching-based prediction of a chroma block is to be performed, when the first information indicates the template matching-based prediction of the chroma block being performed, determining block vector(s) for the chroma block by using block vector(s) for luma block(s), determining search region(s) by using the block vector(s) for the chroma block, calculating variable value(s) by performing template matching between a template of the chroma block and the search region(s), and determining reference block(s) that are based on the variable value(s), generating a prediction list for the chroma block by using template cost(s) and the reference block(s), sorting the prediction list for the chroma block by using the variable value(s), and generating a prediction block of the chroma block by using first reference block(s) within the prediction list for the chroma block.

### TECHNICAL FIELD

The present disclosure in some embodiments relates to a video encoding/decoding method and apparatus using a template of a chroma block. More particularly, the present disclosure relates to video encoding/decoding methods and apparatuses that generate a prediction block of the chroma block through template matching by determining the chroma block's block vector and using the block vector-based determined region.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

In encoding/decoding using template matching-based prediction, the reference block corresponding to a template most similar to the template of the current block is used as the matching block. During template matching-based decoding, the decoder searches for the matching block based on template matching between the templates of reference blocks and the template of the current block, and determines the prediction block of the current block with the searched matching block. The decoder uses Sum of Absolute Differences (SAD) or sum squared errors (SSE) to calculate similarity based on template matching. Since it performs template matching by using multiple reconstructed reference blocks, the template matching-based prediction increases the computational complexity of the video decoding process. To reduce computational complexity, template matching is performed by defining a search region for locating the reference block. As illustrated in FIG. 6, R1, R2, R3, and R4 correspond to the search regions for template search.

Template matching-based prediction techniques are being utilized recently to enhance the image quality of video frames. In particular, to increase the video coding efficiency of chroma blocks and enhance video quality, there is a need for efficient utilization of such template matching-based prediction techniques.

### DISCLOSURE

### Technical Problem

The present disclosure in some embodiments seeks to provide methods and apparatus that generate a prediction list for a chroma block through template matching by using the chroma block's block vector-based region.

Further, the present disclosure seeks to provide methods and apparatus using a template cost to reorder the prediction list for the chroma block and thereby generate a prediction block of the chroma block.

The present disclosure further seeks to provide methods and apparatus for increasing video encoding/decoding efficiency.

The present disclosure further seeks to provide a recording medium storing a bitstream generated by video encoding/decoding methods or apparatus of the present disclosure.

The present disclosure further seeks to provide a method and device for transmitting a bitstream generated by the video encoding/decoding methods or apparatus of the present disclosure.

### SUMMARY

The present disclosure in at least one embodiment provides a video decoding method, including obtaining first information indicating whether a template matching-based prediction of a chroma block is to be performed, and when the first information indicates the template matching-based prediction of the chroma block being performed, determining one or more block vectors for the chroma block by using one or more block vectors for one or more luma blocks that correspond to the chroma block, determining one or more search regions by using the one or more block vectors for the chroma block, calculating one or more variable values by performing template matching between a template of the chroma block and the one or more search regions, and determining one or more reference blocks that are based on the one or more variable values, generating a prediction list for the chroma block by using one or more template costs and the one or more reference blocks, sorting the prediction list for the chroma block by using the one or more variable values, and generating a prediction block of the chroma block by using one or more first reference blocks within the prediction list for the chroma block.

The present disclosure in another embodiment provides a video encoding method, including determining whether a template matching-based prediction of a chroma block is to be performed, encoding first information indicating whether the template matching-based prediction of the chroma block is to be performed, and when the first information indicates the template matching-based prediction of the chroma block being performed, determining one or more block vectors for the chroma block by using one or more block vectors for one or more luma blocks that correspond to the chroma block, determining one or more search regions by using the one or more block vectors for the chroma block, calculating one or more variable values by performing template matching between a template of the chroma block and the one or more search regions, and determining one or more reference blocks that are based on the one or more variable values, generating a prediction list for the chroma block by using one or more template costs and the one or more reference blocks, sorting the prediction list for the chroma block by using the one or more variable values, and generating a prediction block of the chroma block by using one or more first reference blocks within the prediction list for the chroma block.

Further, the present disclosure provides a method of transmitting a bitstream generated by the video encoding methods or apparatuses according to the present disclosure.

Further, the present disclosure provides a recording medium storing a bitstream generated by the video encoding methods or apparatuses according to the present disclosure.

Further, the present disclosure provides a recording medium storing a bitstream that is received, decoded, and utilized to reconstruct a video by the video decoding apparatuses according to the present disclosure.

### Advantageous Effects

As described above, the present disclosure in some embodiments can provide methods and apparatus that generate a prediction list for a chroma block through template matching by using the chroma block's block vector-based region.

Further, the present disclosure can provide methods and apparatus using a template cost to reorder the prediction list for the chroma block and thereby generate a prediction block of the chroma block.

Further, the present disclosure can provide methods and apparatus for increasing video encoding/decoding efficiency.

Effects obtainable with the present disclosure are not limited to the above-mentioned effect, and other unmentioned effects could be clearly understood by those skilled in the art from the description below.

### BRIEF DESCRIPTION OF THE DRAWINGS

FIG. 1 is a block diagram of a video encoding apparatus that may implement the techniques of the present disclosure.

FIG. 2 illustrates a method for splitting a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a search region for template search according to at least one embodiment of the present disclosure.

FIG. 7 is a flowchart of a reconstruction of a current block performed by a video decoding apparatus, according to at least one embodiment of the present disclosure.

FIG. 8 is a diagram illustrating a filter for filtering a prediction block based on template matching, according to at least one embodiment of the present disclosure.

FIG. 9 is a diagram illustrating the multi-model linear model mode (MMLM mode) according to at least one embodiment of the present disclosure.

FIG. 10 is a diagram illustrating the Decoder-side Intra Mode Derivation (DIMD) chroma mode according to at least one embodiment of the present disclosure.

FIG. 11 is a diagram illustrating a reference region used for deriving filter coefficients according to at least one embodiment of the present disclosure.

FIG. 12 is a diagram illustrating Sobel filters for gradient calculation according to at least one embodiment of the present disclosure.

FIG. 13 is a diagram illustrating candidate luma blocks in direct block vector mode (DBV mode), according to at least one embodiment of the present disclosure.

FIG. 14 is a diagram illustrating candidate luma blocks in DBV mode, according to another at least one embodiment of the present disclosure.

FIG. 15 is a diagram illustrating prediction of a chroma block in DBV mode, according to at least one embodiment of the present disclosure.

FIG. 16 is a diagram illustrating a search region for a template search of a chroma block according to at least one embodiment of the present disclosure.

FIG. 17 is a flowchart of a video decoding process according to at least one embodiment of the present disclosure.

FIG. 18 is a flowchart of a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

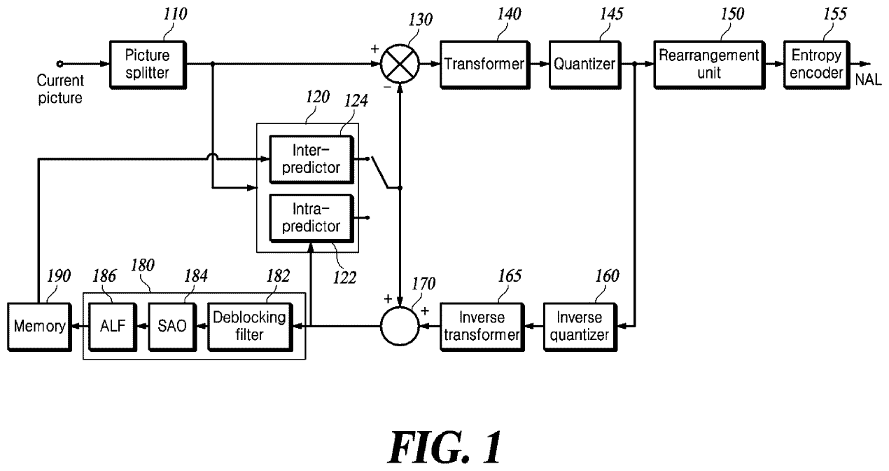

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

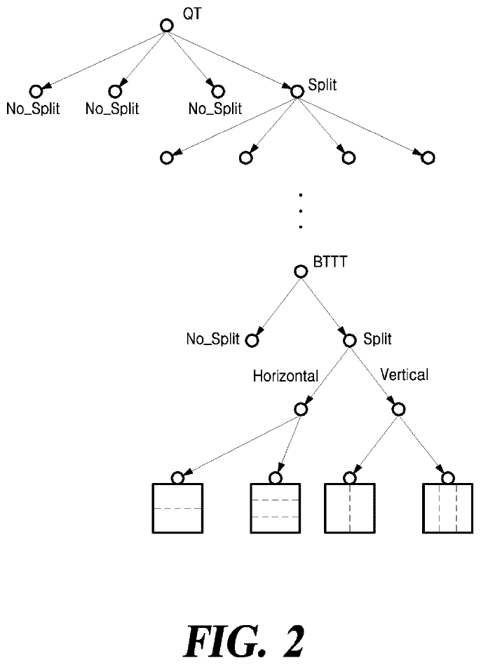

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

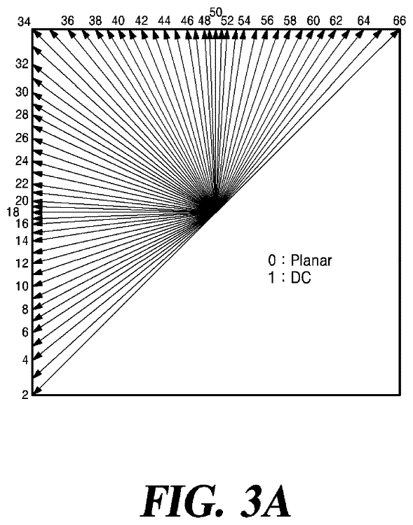

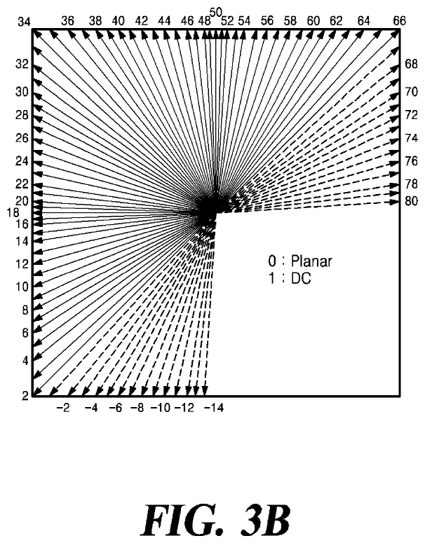

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

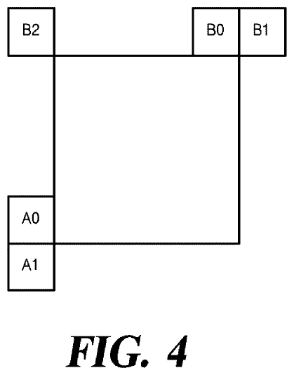

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding apparatus may store a bitstream of encoded video data in a non-transitory storage medium or transmit the bitstream to the video decoding device through a communication network.

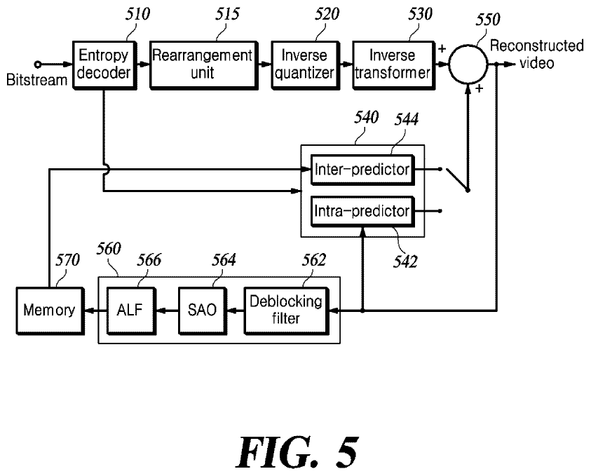

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The following embodiments may be performed by various components in the video encoding apparatus. In addition, they may be performed by various components in the video decoding apparatus.

The video encoding apparatus in the encoding of the current block may generate signaling information associated with the embodiments of the present disclosure in terms of optimizing bit rate distortion. The video encoding apparatus may use the entropy encoding unit 155 to encode and transmit the signaling information to the video decoding apparatus. The video decoding apparatus may use the entropy decoding unit 510 to decode from the bitstream the signaling information associated with the decoding of the current block.

In the following description, the term ‘target block’ may be used interchangeably with the current block or a coding unit (CU). The ‘target block’ may also refer to some area of a coding unit.

Further, the value of a flag being true indicates when the flag is set to 1. Additionally, the value of a flag being false indicates when the flag is set to 0.

### I. Template Matching-Based Prediction

In encoding/decoding using a template matching-based prediction, one uses as a matching block a reference block corresponding to a template most similar to the template of the current block. In template matching-based decoding, the video decoding apparatus searches for a matching block based on the template matching between the templates of the reference blocks and the template of the current block, and determines the prediction block of the current block as the searched matching block. In other words, the matching block represents the (selected) reference block according to template matching. Hereafter, the template of the reference block is used interchangeably with the reference template, and the template of the current block is used interchangeably with the current template.

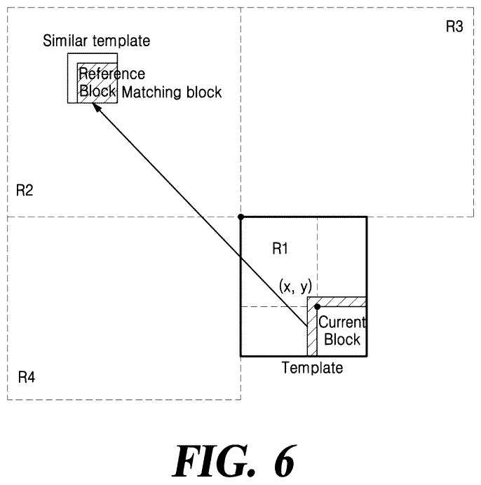

The video decoding apparatus uses a measure such as Sum of Absolute Differences (SAD), Sum Squared Errors (SSE), etc. to calculate the similarity based on template matching. Since template matching is performed by using multiple reconstructed reference blocks, template matching-based prediction increases the computational complexity of the video decoding process. To reduce the computational complexity, template matching is performed by defining a search region to search for reference blocks. As illustrated in FIG. 6, R1, R2, R3, and R4 correspond to the search regions for template search. In the example of FIG. 6, (x,y) denotes the position of the top left sample of the current block.

Hereinafter, a mode for predicting the current block based on template matching is referred to as a template matching-based prediction mode. Additionally, a method of intra predicting the current block by using the template matching-based prediction mode is referred to as template matching-based intra prediction or intra-template matching prediction (intraTMP). Hereafter, template matching-based intra prediction and template matching-based prediction are used interchangeably. Template matching and intra-template matching are used interchangeably.

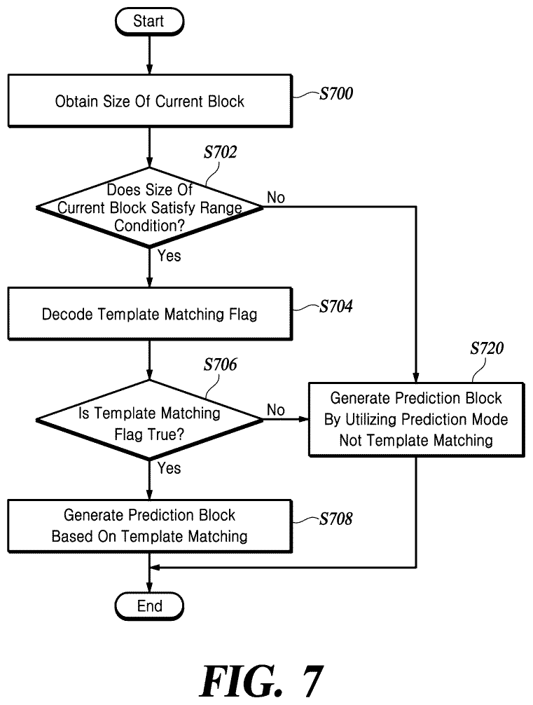

Referring now to FIG. 7, a method of predicting and reconstructing a current block by using a template matching-based prediction mode will be described.

FIG. 7 is a flowchart of a reconstruction of a current block performed by the video decoding apparatus, according to at least one embodiment of the present disclosure.

The video decoding apparatus obtains the size of the current block (S700). The video decoding apparatus may obtain, before obtaining the current block's size, information indicating the applicability of the presently disclosed method of generating a prediction block of a chroma block by performing template matching. The information indicating the applicability of the presently disclosed method of generating a chroma block's prediction block through the template matching, may be flag-type information. The video encoding apparatus may signal the information indicating the applicability of the presently disclosed method of generating a chroma block's prediction block through the template matching, at sequence level, picture level, slice level, or tile level, among others. The video encoding apparatus may signal, at a CTU level or a CU level, etc. the information indicating the applicability of the presently disclosed method of generating a chroma block's prediction block through the template matching.

The video decoding apparatus determines whether the size of the current block satisfies a range condition (S702). The video decoding apparatus determines whether the size of the current block satisfies a range condition for decoding based on the template matching-based prediction. For example, the range condition refers to a minimum size condition of the current block and/or a maximum size condition of the current block. Depending on whether the range condition is satisfied, the reconstruction process is divided into a reconstruction process that utilizes template matching and a reconstruction process that does not utilize template matching.

If the range condition is satisfied (Yes in S702), the video decoding apparatus decodes a template matching flag (S704). The template matching flag indicates whether intra-template matching is to be used for the current block.

The video decoding apparatus checks the template matching flag (S706).

If the template matching flag is true (Yes in S706), the video decoding apparatus generates a prediction block of the current block based on the template matching (S708).

If the range condition is not satisfied (No in S702) or the template matching flag is false (No in S706), the video decoding apparatus generates the prediction block of the current block by utilizing a prediction mode that does not use template matching (S720). For example, the video decoding apparatus may utilize an intra-prediction mode that does not use template matching or utilize an inter-prediction mode.

The video decoding apparatus may then decode the residual block and sum the residual block and the prediction block to generate a reconstructed block of the current block.

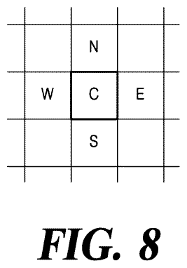

Meanwhile, filtering may be applied to the intra-template matching prediction. The filter is applied to a matching block, and the resultantly filtered matching block is utilized as the prediction block of the current block. For example, the filter is a 6-tap linear filter that is cross-shaped with five luma taps and one bias term. As illustrated in FIG. 8, the input to the spatial 5-tap component of the filter is composed of the reference block's center (C) sample, top/north (N) sample, bottom/south (S) sample, left/west (W) sample, and right/east (E) sample at locations corresponding to the samples of the current block. Hereinafter, the 6-tap filter is also referred to as a 5-tap filter without considering the bias term.

The output of the filter is calculated as shown in Equation 1.

$$predLumaVal = c 0 C + c 1 N + c 2 S + c 3 E + c 4 W + c 5 B \qquad Equation 1$$

In Equation 1, B denotes the bias term.

The filter coefficients c0 to c5 shown in Equation 1 are derived for each block by using a regression model that minimizes the mean square error (MSE) between the output of the filter and the samples in the template of the current block. MSE minimization includes calculation of an autocorrelation matrix between the reference template and the current template, LDL decomposition of the autocorrelation matrix, and calculation of filter coefficients by back-substitution.

A filter flag, which indicates whether the filter is to be used, is sent from the video encoding apparatus to the video decoding apparatus at the CU level. Furthermore, the use of the linear filter is considered a sub-mode of the intra-template matching prediction. For example, if a template matching flag, which indicates whether the intra-template matching prediction is to be used, is true, the filter flag is signaled.

The output prdChromaVal of the filter for the chroma block may be expressed by the following equation: predChromaVal=c₀+c₁N+c₂S+c₃E+c₄W+c₅P+c₆B where C is the center sample of the matching block, N is the top sample of the matching block, S is the bottom sample of the matching block, W is the left sample of the matching block, and E is the right sample of the matching block. P is the nonlinear term, and B is the offset. P is expressed as a power of C and may be scaled by the bit depth.

In another embodiment, the output prdChromaVal of the filter for the chroma block may be expressed by the following equation: predChromaVal=c₀C+c₁N+c₂S+c₃E+c₄W+c₅P(C)+c₆P(N)+c₇P(S)+c₈P(W)+c₉P(E)+c₁₀B where C is the center sample of the matching block, N is the top sample of the matching block, S is the bottom sample of the matching block, W is the left sample of the matching block, and E is the right sample of the matching block. P is the squared term for each sample, and B is the offset. The prediction block of the chroma block may be generated by downsampling the luma sample.

### II. Chroma Prediction Mode of Enhanced Compression Model (ECM)

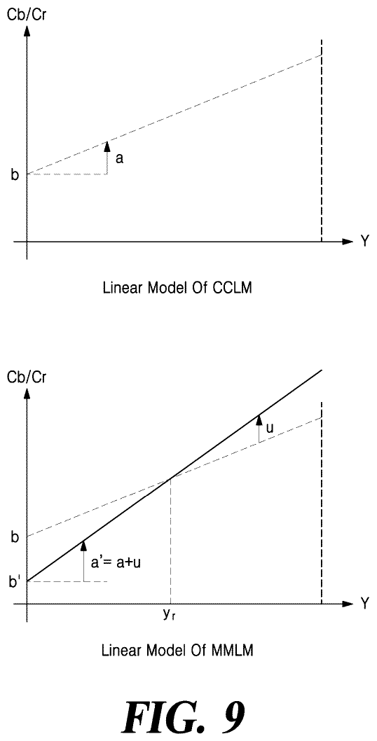

In the ECM corresponding to Beyond VVC (versatile video coding), a Multi-model LM mode (MMLM mode) is added, which is an extension of the Cross-component Linear Model (CCLM) included in the existing VVC. The MMLM mode derives a linear model by applying the least mean square (LMS) method to luma samples and improves accuracy by adjusting the gradient of the linear model. As illustrated in FIG. 9, gradient adjustment is performed by using a linear function that maps luma values to chroma values based on a center point determined by the average luma value of the reference sample. The linear function of MMLM mode is derived from the linear function of CCLM mode as shown in Equation 2.

$$chromaVal = {a}^{′} \cdot lumaVal + {b}^{′} \qquad Equation 2$$

$${a}^{′} + a + u , {b}^{′} = b - u \cdot {y}_{r}$$

In Equation 2, a and b are parameters representing the linear model of the CCLM mode illustrated in FIG. 9, while a′ and b′ are parameters representing the linear function of the MMLM mode. yᵣ denotes the reference luma sample value corresponding to the center point.

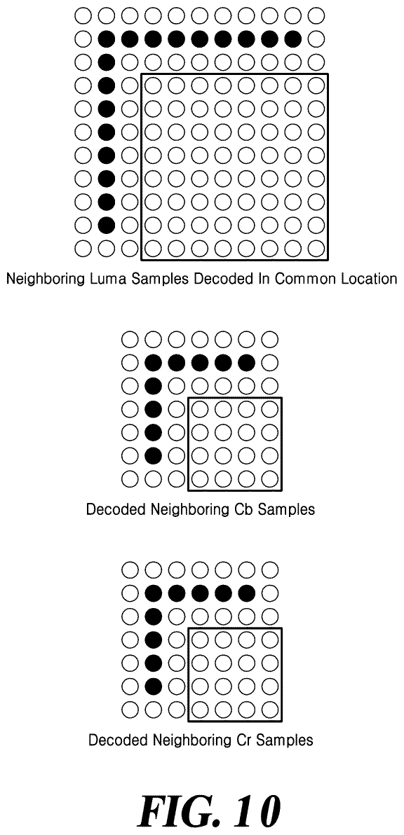

A Decoder-side Intra Mode Derivation chroma (DIMD chroma) determines the intra prediction mode of the current chroma block. As illustrated in FIG. 10, the DIMD chroma mode is used based on the neighboring luma samples and chroma samples decoded from the neighboring rows and columns. With horizontal and vertical gradient calculations performed on the luma samples, Cb and Cr samples decoded at the same position in the current chroma block, a histogram of gradient is calculated. The prediction mode with the largest histogram value is used for intra prediction of the current chroma block. If the intra-prediction mode derived according to the DIMD chroma mode is identical to the intra-prediction mode according to the DM mode, the intra-prediction mode with the second largest histogram value is used for the intra prediction of the current chroma block. A CU-level flag may be signaled to indicate the applicability of the DIMD chroma mode.

In ECM, two chroma prediction blocks may be fused together to generate the final prediction signals as shown in Equation 3.

$${pred}_{C} ( i , j ) = ( w 0 \times pred 0 ( i , j ) + w 1 \times pred 1 ( i , j ) + ( 1 ≪ ( shift - 1 ) ) ) ≫ shift \qquad Equation 3$$

In Equation 3, one of the two chroma prediction blocks is generated according to either the derived mode (DM), DIMD chroma mode, or one of the four basic modes (non-LM modes). The other prediction block may be generated according to the cross-component linear prediction mode. For example, pred0(i,j) may be predicted according to the non-linear model mode (non-LM mode), and pred1 (i,j) may be predicted according to the MMLM_LT mode. The four basic modes represent DC mode, planar mode, horizontal mode (No. 18), and vertical mode (No. 50). The MMLM_LT mode represents the MMLM mode that utilizes left and top samples to derive the linear model.

In Equation 3, the weights w0 and w1 are determined based on the intra-prediction mode of the adjacent chroma block, and the shift is set to 2. When both the top and left adjacent blocks are encoded in LM mode, {w0, w1}={1, 3}. When neither the top nor left adjacent blocks are encoded in LM mode, {w0, w1}={3, 1}. In all other cases, {w0, w1}={2, 2}.

As another example, the final prediction signals may be generated as shown in Equation 4.

$${pred}_{C} ( i , j ) = {α}_{0} \times pred 0 ( i , j ) + {α}_{1} \times {rec}_{L}^{′} ( i , j ) + {α}_{2} \times β \qquad Equation 4$$

In Equation 4, pred0(i,j) is predicted according to the non-LM mode, and rec′_{L}(i,j) represents the downsampled co-located luma sample.

The convolutional cross-component model mode (CCCM mode) predicts chroma samples from reconstructed luma samples, similar to the CCLM mode. When chroma subsampling is used, the CCCM mode downsamples the luma samples to align their positions with the chroma samples and thereby compensates for the resolution difference between luma samples and chroma samples. CCCM mode calculates the model by using top, left, or top-left reference samples.

The 7-tap convolutional filter in CCCM mode is composed of a 5-tap cross-shaped spatial component, a nonlinear term, and a bias term. The 5-tap component of the filter may be represented as illustrated in FIG. 8. For example, the 5-tap component of the filter is composed of the central (C) luma sample, the down/south (S), left/west (W), right/east (E), and up/north (N) samples.

The nonlinear term P is expressed as a power of the central luma sample C, as shown in Equation 5, and is scaled by the bit depth.

$$P = ( C \cdot C + midVal ) ≫ bitDepth \qquad Equation 5$$

For images with 10-bit depth, the nonlinear term P is expressed as in Equation 6.

$$P = ( C \cdot C + 512 ) ≫ 10 \qquad Equation 6$$

The bias term B represents a scalar offset between the input and output, and is the mid-chroma value that is 512 for images with 10-bit depth. The output of the convolution filter is calculated as the convolution between the filter coefficient cᵢ and the input value, and is clipped to the valid range of chroma samples. The convolution filter finally calculates the predicted value as shown in Equation 7.

$$predChromaVal = {c}_{0} C + {c}_{1} N + {c}_{2} S + {c}_{3} E + {c}_{4} W + {c}_{5} P + {c}_{6} B \qquad Equation 7$$

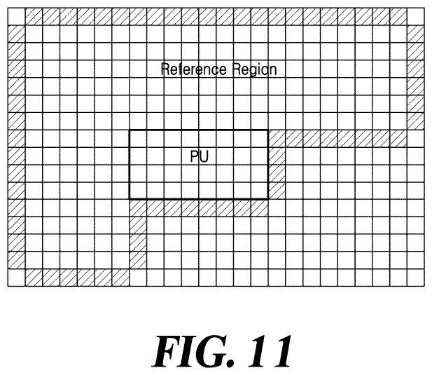

The filter coefficient cᵢ is calculated to minimize the mean square error (MSE) between the predicted chroma sample and the reconstructed chroma sample within the reference region. In the example of FIG. 11, the six lines positioned at the top and left of the prediction unit (PU) represent the reference region of the chroma sample. The reference region is expanded toward the bottom-left and top-right of the border of the PU by an area equal to the width and height of the PU, respectively. The hatched area around the reference region and prediction unit may be used to derive a cross-shaped spatial filter, and unusable areas may be padded to be usable.

MSE minimization is computed by using the autocorrelation matrix for the luma sample and the cross-correlation vector between the luma input and chroma output. The autocorrelation matrix undergoes LDL decomposition, and the final filter coefficients are computed via back-substitution. MSE minimization roughly follows the process of calculating ALF filter coefficients in ECM. However, LDL decomposition is used instead of Cholesky decomposition to avoid square root operations.

A gradient linear model (GLM) when in the YUV 4:2:0 color format is used to predict the chroma sample from the luma sample gradient. A GLM mode uses either two or three variables. When using two variables, the GLM utilizes the luma sample gradient to derive a linear model. In this case, the derivation method for the CCLM parameters and the linear transform of the predicted sample remain unchanged and are used in its original form. In the GLM using two variables, the chroma sample C is expressed as in Equation 8.

$$C = α \cdot G + β \qquad Equation 8$$

In Equation 8, α and β represent the linear model's parameters derived according to the CCLM mode, and G denotes the gradient.

The GLM mode using three variables predicts the chroma sample based on the luma sample gradient and the downsampled luma value. The model parameters for the 3-variables GLM are derived by using the rows and columns of the adjacent six samples, based on the LDL decomposition-based MSE minimization method used in CCCM. In the 3-variables GLM, the chroma sample C is expressed as in Equation 9.

$$C = {α}_{0} \cdot G + {α}_{1} \cdot L + {α}_{2} \cdot B \qquad Equation 9$$

In Equation 9, G and L represent the luma sample gradient and the downsampled luma value, respectively, while α₀, α₁, and β denote the parameters of the GLM model.

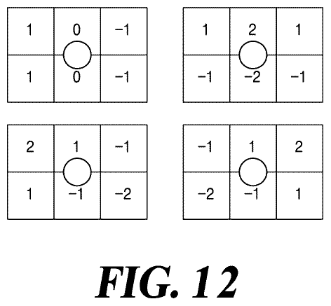

From a signaling perspective, when the CCLM mode is enabled with the current CU, the present disclosure signals a flag indicating whether the GLM is to be enabled for both the Cb and Cr components. When the GLM is enabled, another flag indicating one of the two GLM modes is signaled. Additionally, as illustrated in FIG. 12, the present disclosure also signals a filter index indicating one of the four Sobel filters for gradient calculation. In the example of FIG. 12, the circle at the center of each filter indicates the position of the chroma sample corresponding to the six luma samples.

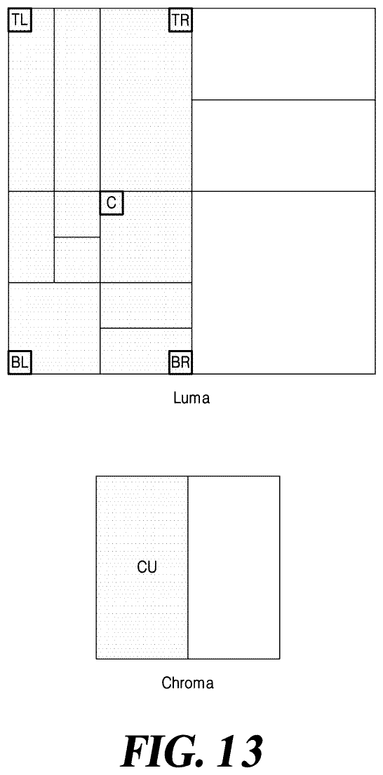

Direct block vector mode (DBV mode) is used for the chroma block in dual tree slices. When dual tree is enabled, a flag is displayed indicating whether the chroma block was encoded by using intra block copy (IBC) mode. When DBV mode is enabled, the chroma block's position and the candidate luma blocks' positions correspond to those illustrated in FIG. 13. In FIG. 13, the candidate luma blocks are located in the chroma block's corresponding luma region at the center, top left, top right, bottom left, and bottom right. When one of the five candidate luma blocks corresponding to the chroma block encoded in DBV mode is encoded in IBC mode or intraTMP mode, the one luma block's block vector Luma (bvL) is used to derive the chroma block's block vector Chroma (bvC). The luma block's block vector is resized and used as the chroma block's block vector. In another embodiment, the luma block's block vector unscaled may be directly used as the chroma block's block vector. When template matching is used for block vector scaling and the luma block is encoded by using Reconstruction Reordered IBC (RR-IBC), horizontal or vertical block vector (BV) adjustment is performed on the bvL in the same manner as RR-IBC.

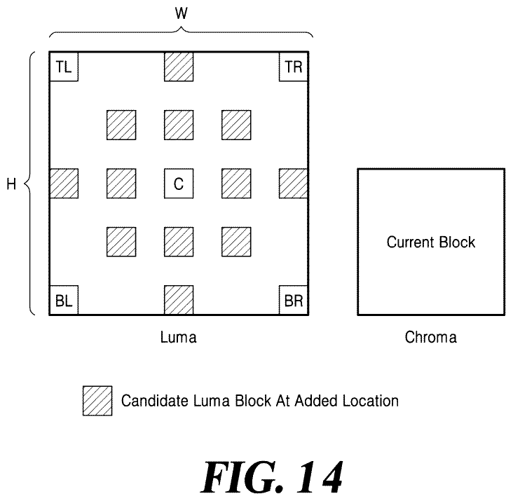

Another embodiment, as illustrated in FIG. 14, adds twelve additional candidate luma blocks to the candidate luma blocks shown in FIG. 13 within the corresponding luma region to the chroma block. Accordingly, the positions of the total 17 candidate luma blocks may be (0, 0), (W/2, 0), (W−1, 0), (W/4, H/4), (W/2, H/4), (3×W/4, H/4), (0, H/2), (W/4, H/2), (W/2, H/2), (3×W/4, H/2), (W−1, H/2), (W/4, 3×H/4), (W/2, 3×H/4), (3×W/4, 3×H/4), (0, H−1), (W/2, H−1), and (W−1, H−1).

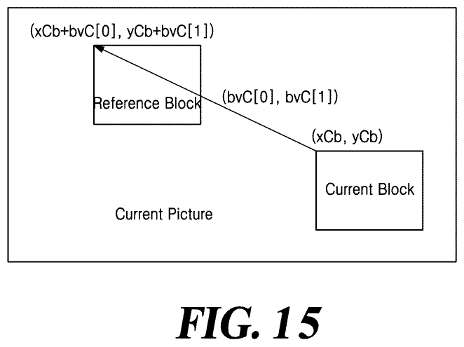

As illustrated in FIG. 15, the DBV mode uses the current chroma block's position (xCb, yCb) and bvC's position to determine the offset position (xCb+bvC[0], yCb+bvC[1]), and predicts the chroma block.

### Template Cost of the Chroma Block

The template cost of the chroma block is calculated to determine the mode to be used in cross-component prediction (CCP). The template cost may be calculated by applying CCP candidates to the chroma block template and using the SAD between the predicted sample and the reconstructed sample. In the CCCM mode, CCCM-L (Left) mode, and CCCM-T (Top) mode, two template costs are calculated by using adjacent samples from 6 lines or 2 lines, respectively, as the derived samples for the parameters. In Multi Model-CCCM mode (MM-CCCM mode), MM-CCCM-L (Left) mode, and MM-CCCM-T (Top) mode, adjacent luma samples or luma samples associated with the current chroma block are used to determine the average value as the threshold to separate two models, and thereby calculate two template costs. In a chroma fusion mode, two template costs are calculated by fusing each mode with either Multi Model CCLM mode (MM-CCLM mode) or the MM-CCCM mode. The mode with the lower template cost is selected as the final mode for the current block in the CCP.

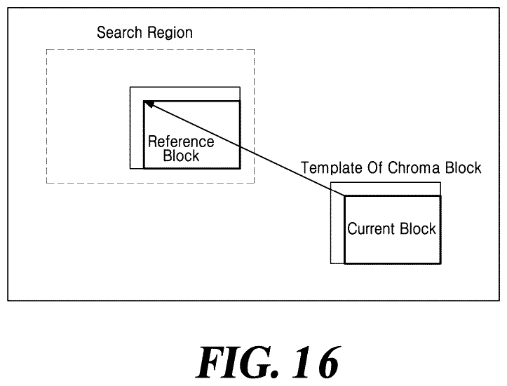

FIG. 16 is a diagram illustrating a search region for a template search of a chroma block according to at least one embodiment of the present disclosure.

Referring to FIG. 16, when direct mode (DM) is applied to the current block and either the intra block copy mode (IBC mode) or the intra template matching prediction mode is applied to the luma block of the current block, the video decoding apparatus uses the block vector of the luma block to determine the block vector of the chroma block. When DBV mode is applied to the chroma block and there is a number C of luma blocks corresponding to the chroma block and including a block that is subjected to the IBC mode or intra template matching prediction mode, the video decoding apparatus uses the block vector of the luma block to determine the block vector of the chroma block.

When the current slice is an I-slice and has a dual tree block partitioning structure, the video decoding apparatus uses the block vector of the luma block to determine the block vector of the chroma block. When the current slice is an I-slice and has a single tree block partitioning structure, the video decoding apparatus uses the block vector of the luma block to determine the block vector of the chroma block. When the current slice, regardless of the slice type, has a dual tree block partitioning structure, the video decoding apparatus uses the block vector of the luma block to determine the block vector of the chroma block. When the current slice, regardless of the slice type, has a single tree block partitioning structure, the video decoding apparatus uses the block vector of the luma block to determine the block vector of the chroma block.

By using the determined block vector of the chroma block, the offset position is determined. The video decoding apparatus determines the search region based on the offset position as a reference point. Here, the search region is the area where template matching is performed with the chroma block template. The search region may be a fixed area or an area proportional to the size of the current block. For example, when the search region is a fixed area, its size may be identical to that a coding tree unit (CTU). When the search region is proportional to the size of the current block, the search region size may be M times the size of the current block. Here, M may be any positive integer.

The video decoding apparatus performs template matching between the template of the chroma block and the search region to calculate a template cost. The video decoding apparatus determines the position of the block with the minimum template cost as the position of the reference block and use this reference block to generate the prediction block of the chroma block. Here, the block with the minimum template cost is a block that is within the search region and corresponds to the template most closely matches the template of the chroma block.

### Method of Generating a Prediction Block of Chroma Block by Using a Prediction List for a Chroma Block

When the DBV mode (direct block vector mode) is applied to a chroma block and there are C block vectors existing for the C luma blocks corresponding to the chroma block, the video decoding apparatus may use the C luma blocks' block vectors to determine the C chroma blocks' block vectors. Here, C may be any positive integer. For example, C may be 5 or 17. The video decoding apparatus uses the C chroma blocks' block vectors to determine C offset positions. The video decoding apparatus performs template matching between C templates based on the C offset positions and the chroma block's template to calculate a template cost. The video decoding apparatus uses the reference blocks corresponding to the C templates and their respective template costs to generate a prediction list for the chroma block.

The video decoding apparatus uses the C offset positions determined by using the C chroma blocks' block vectors to determine C search regions. Here, the C search regions are the areas where template matching is performed with the chroma block's template. The C search regions may be fixed areas or areas proportional to the size of the current block. For example, when the C search regions are fixed areas, their size may be identical to that of a CTU. When the C search regions are proportional to the size of the current block, the C search regions' size may be M times the size of the current block. Here, M may be any positive integer. The video decoding apparatus performs template matching between the chroma block's template and the C search regions to calculate the template cost. The video decoding apparatus generates a prediction list for the chroma block by using the reference blocks and their respective template costs, wherein the reference blocks are determined based on the template matching between the chroma block's template and the C search regions.

The video decoding apparatus may use the respective calculated template costs to sort the prediction list for the chroma block. The prediction list for the chroma block may be sorted in ascending order of template costs. The video decoding apparatus may use the reference block with the minimum template cost within the prediction list for the chroma block to generate the prediction block of a chroma block. The video encoding apparatus may signal the index of the reference block with the minimum template cost within the prediction list for the chroma block.

The video decoding apparatus may linearly combine and utilize a number K of x components and a number L of y components among the (x, y) components of the block vectors of C chroma blocks. Here, K and L may be positive integers of 1 or more. For example, when K and L are 1, the video decoding apparatus may determine those x and y components as the (x, y) components of the chroma block's block vector.

Method of Generating a Prediction Block of the Chroma Block by Using Multiple Reference Blocks within the Prediction List for the Chroma Block

When multiple reference blocks within the prediction list for the chroma block are utilized, the video decoding apparatus may weighted sum the multiple reference blocks to generate the prediction block of the chroma block. In this case, the video encoding apparatus may signal the indices for the multiple reference blocks used in the prediction list for the chroma block. The video decoding apparatus may use predefined weights to weight-sum the multiple reference blocks. For example, when using three reference blocks with respective weights being w₀, w₁, and w₂, the prediction block of the chroma block may be expressed as shown in Equation 10.

$$Cb = {w}_{0} {Cb}_{0} + {w}_{1} {Cb}_{1} + {w}_{2} {Cb}_{2} \qquad Equation 10$$

Here, Cb is the prediction block of the chroma block, and Cb₀, Cb₁, and Cb₂ are the three reference blocks used in the prediction list for the chroma block. The sum of w₀, w₁, and w₂ is 1, and w₀, w₁, and w₂ are all greater than 0. w₀, w₁, and w₂ may be predefined values or variable values.

### Method of Signaling Information Related to Chroma Block Prediction

The video encoding apparatus signals information indicating the applicability of the method of generating a chroma block's prediction block through the template matching. The information indicating the applicability of the method of generating a chroma block's prediction block through the template matching may be signaled at levels such as sequence, picture, subpicture, slice, or tile. The information indicating the applicability of the method of generating a chroma block's prediction block through the template matching may be signaled at block unit levels such as CTU or CU. The video encoding apparatus signals the indices for the reference blocks used in the prediction list for the chroma block. When multiple reference blocks are used within the prediction list for the chroma block, the video encoding apparatus signals the indices for the weights used to perform the weighted summation of the multiple reference blocks.

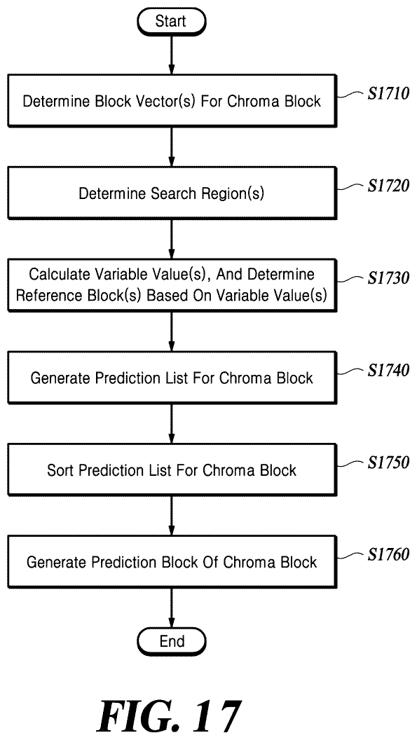

FIG. 17 is a flowchart of a video decoding process according to at least one embodiment of the present disclosure.

Referring to FIG. 17, the video decoding apparatus obtains first information indicating whether prediction of the chroma block is to be performed based on template matching. When the first information indicates performing prediction of the chroma block based on template matching, the video decoding apparatus uses one or more block vectors for one or more luma blocks to determine one or more block vectors for the chroma block (S1710). The luma block(s) is a block that corresponds to the chroma block. The process of determining the block vector(s) for the chroma block may include scaling the block vector(s) for the luma block(s) before determining the block vector(s) for the chroma block, when intra block copy (IBC) mode or template matching-based intra prediction is applied to the luma block(s).

The video decoding apparatus uses the block vector(s) for the chroma block to determine one or more search regions (S1720). The size of the search region may be a predefined size or proportional to the size of the current block. The video decoding apparatus performs template matching between the chroma block's template and the search region(s) to calculate variable value(s) and determines reference block(s) based on the variable value(s) (S1730). The video decoding apparatus uses the template cost(s) and the reference block(s) to generate a prediction list for the chroma block (S1740). The video decoding apparatus uses the variable value(s) to sort the prediction list for the chroma block (S1750). The process of sorting the prediction list for the chroma block may include sorting the prediction list for the chroma block in ascending order of the variable values.

The video decoding apparatus uses a first reference block(s) within the prediction list for the chroma block to generate a prediction block of the chroma block (S1760). The process of generating the prediction block of the chroma block may include generating the prediction block by using a first reference block for the minimum value among variable values within the prediction list for the chroma block. The process of generating the prediction block of the chroma block may include a process of generating the prediction block of the chroma block by weighted averaging multiple first reference blocks as used from among the reference blocks within the prediction list for the chroma block.

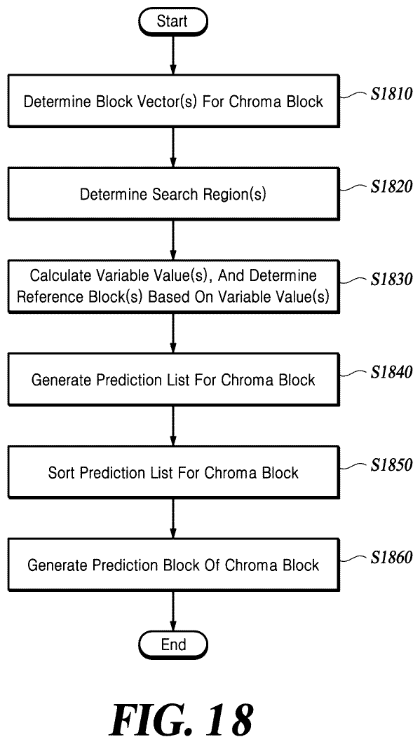

FIG. 18 is a flowchart of a video encoding process according to at least one embodiment of the present disclosure.

Referring to FIG. 18, the video encoding apparatus determines whether prediction is to be performed on the chroma block based on template matching. The video encoding apparatus encodes first information indicating whether prediction of the chroma block is to be performed based on template matching. When the first information indicates performing prediction based on template matching, the video encoding apparatus uses block vector(s) for the luma block(s) to determine block vector(s) for the chroma block (S1810). The luma block(s) is a block that correspond to the chroma block. The process of determining the block vector(s) for the chroma block may include scaling the block vector(s) for the luma block(s) before determining the block vector(s) for the chroma block, if IBC mode or template matching-based intra prediction is applied to the luma block(s).

The video encoding apparatus uses the block vector(s) for the chroma block to determine search region(s) (S1820). The size of the search region may be a predefined size or proportional to the size of the current block. The video encoding apparatus performs template matching between the chroma block's template and the search region(s) to calculate variable value(s), and determines reference block(s) based on the variable value(s) (S1830). The video encoding apparatus uses the template cost(s) and the reference block(s) to generate a prediction list for the chroma block (S1840). The video encoding apparatus uses the variable value(s) to sort the prediction list for the chroma block (S1850). The process of sorting the prediction list for the chroma block may include sorting the prediction list of the chroma block in ascending order of the variable value(s).

The video encoding apparatus uses a first reference block(s) within the prediction list for the chroma block to generate a prediction block of the chroma block (S1860). The process of generating the prediction block of the chroma block may include generating the prediction block by using the first reference block for the minimum value among the variable value(s) within the prediction list for the chroma block. The process of generating the prediction block of the chroma block may include generating the prediction block of the chroma block by weighted averaging multiple first reference blocks as used from among the reference blocks within the prediction list for the chroma block.

Although the steps in the respective flowcharts/timing charts are described in this specification as being sequentially performed, they merely instantiate the technical idea of some embodiments of the present disclosure. Therefore, a person having ordinary skill in the pertinent art could perform the steps by changing the sequences described in the respective flowcharts/timing charts or by performing two or more of the steps in parallel, and hence the steps in the respective flowcharts/timing charts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium includes, for example, all types of recording devices in which data is stored in a form readable by a computer system. For example, the non-transitory recording medium may include storage media such as erasable programmable read-only memory (EPROM), flash drive, optical drive, magnetic hard drive, and solid state drive (SSD), among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### CROSS-REFERENCE TO RELATED APPLICATION

This application claims priority from Korean Patent Application No. 10-2023-0063894 filed on May 17, 2023, and Korean Patent Application No. 10-2024-0060588 filed on May 8, 2024, the disclosures of which are incorporated by reference herein in their entirety.

What is claimed is:

1. A video decoding method, comprising:
obtaining first information indicating whether a template matching-based prediction of a chroma block is to be performed;
when the first information indicates the template matching-based prediction of the chroma block being performed, determining one or more block vectors for the chroma block by using one or more block vectors for one or more luma blocks that correspond to the chroma block;
determining one or more search regions by using the one or more block vectors for the chroma block;
calculating one or more variable values by performing template matching between a template of the chroma block and the one or more search regions, and determining one or more reference blocks that are based on the one or more variable values;
generating a prediction list for the chroma block by using one or more template costs and the one or more reference blocks;
sorting the prediction list for the chroma block by using the one or more variable values; and
generating a prediction block of the chroma block by using one or more first reference blocks within the prediction list for the chroma block.

2. The video decoding method of claim 1, wherein the determining the one or more block vectors for the chroma block comprises:
when intra block copy mode or template matching-based intra prediction is applied to the one or more luma blocks, scaling one or more block vectors for the one or more luma blocks to determine the one or more block vectors for the chroma block.

3. The video decoding method of claim 1, wherein the search region has a predefined size or is proportional in size to a current block.

4. The video decoding method of claim 1, wherein the sorting the prediction list for the chroma block comprises:
sorting the prediction list for the chroma block in ascending order of the one or more variable values.

5. The video decoding method of claim 1, wherein the generating the prediction block of the chroma block comprises:
using a first reference block for a minimum value among the one or more variable values within the prediction list for the chroma block, to generate the prediction block of the chroma block.

6. The video decoding method of claim 1, wherein the generating the prediction block of the chroma block comprises:
when utilizing the first reference blocks within the prediction list for the chroma block, weight averaging the first reference blocks to generate the prediction block of the chroma block.

7. A video encoding method, comprising:
determining whether a template matching-based prediction of a chroma block is to be performed;
encoding first information indicating whether the template matching-based prediction of the chroma block is to be performed;
when the first information indicates the template matching-based prediction of the chroma block being performed, determining one or more block vectors for the chroma block by using one or more block vectors for one or more luma blocks that correspond to the chroma block;
determining one or more search regions by using the one or more block vectors for the chroma block;
calculating one or more variable values by performing template matching between a template of the chroma block and the one or more search regions, and determining one or more reference blocks that are based on the one or more variable values;
generating a prediction list for the chroma block by using one or more template costs and the one or more reference blocks;
sorting the prediction list for the chroma block by using the one or more variable values; and
generating a prediction block of the chroma block by using one or more first reference blocks within the prediction list for the chroma block.

8. The video encoding method of claim 7, wherein the determining the one or more block vectors for the chroma block comprises:
when intra block copy mode or template matching-based intra prediction is applied to the one or more luma blocks, scaling one or more block vectors for the one or more luma blocks to determine the one or more block vectors for the chroma block.

9. The video encoding method of claim 7, wherein the search region has a predefined size or is proportional in size to a current block.

10. The video encoding method of claim 7, wherein the sorting the prediction list for the chroma block comprises:
sorting the prediction list for the chroma block in ascending order of the one or more variable values.

11. The video encoding method of claim 7, wherein the generating the prediction block of the chroma block comprises:
using a first reference block for a minimum value among the one or more variable values within the prediction list for the chroma block, to generate the prediction block of the chroma block.

12. The video encoding method of claim 7, wherein the generating the prediction block of the chroma block comprises:
when utilizing the first reference blocks within the prediction list for the chroma block, weight averaging the first reference blocks to generate the prediction block of the chroma block.

13. A method of transmitting a bitstream associated with video data, the method comprising:
generating the bitstream by encoding the video data; and
transmitting the bitstream to a video decoding apparatus,
wherein the generating of the bitstream comprises:
determining whether a template matching-based prediction of a chroma block is to be performed;
encoding first information indicating whether the template matching-based prediction of the chroma block is to be performed;
when the first information indicates the template matching-based prediction of the chroma block being performed, determining one or more block vectors for the chroma block by using one or more block vectors for one or more luma blocks that correspond to the chroma block;
determining one or more search regions by using the one or more block vectors for the chroma block;
calculating one or more variable values by performing template matching between a template of the chroma block and the one or more search regions, and determining one or more reference blocks that are based on the one or more variable values;
generating a prediction list for the chroma block by using one or more template costs and the one or more reference blocks;
sorting the prediction list for the chroma block by using the one or more variable values; and
generating a prediction block of the chroma block by using one or more first reference blocks within the prediction list for the chroma block.
